(19) United States
(12) Patent Application Publication
(10) Pub. No.: US 2022/0261741 A1
(43) Pub. Date: Aug. 18, 2022

(54) COMMODITY MARKING METHOD, COMMODITY EXHIBITING METHOD, SERVER, TERMINAL, AND COMMODITY EXHIBITING SYSTEM

(71) Applicant: BOE Technology Group Co., Ltd., Beijing (CN)

(72) Inventor: Linyi FAN, Beijing (CN)

(21) Appl. No.: 17/627,262

(22) PCT Filed: Mar. 23, 2021
(86) PCT No.: PCT/CN2021/082450

§ 371 Date: Jan. 14, 2022

(30) Foreign Application Priority Data
Apr. 27, 2020 (CN) 202010344357.7

(51) Int. Cl. G06Q 10/08

(52) U.S. Cl. CPC G06Q 10/087

(57) ABSTRACT

Commodity marking method, commodity exhibiting method, server, terminal, and commodity exhibiting method, relates to the technical field of internet of things. The disclosure determines the target template data from the at least one piece of template data sent by the first terminal, determine the target collection data from at least one collection data sent by the second terminal, comparing the target template data with the target collection data, and marking differences in locations to get the first commodity marking result of first shelf and second shelf, sending the commodity marking result to the third terminal.

### CROSS REFERENCE TO RELEVANT APPLICATIONS

This application is based upon and claims priority of the Chinese patent application filed on Apr. 27, 2020 filed to the Chinese Patent Office with the application number of 202010344357.7 and the title of “COMMODITY MARKING METHOD, COMMODITY EXHIBITING METHOD, SERVER, TERMINAL, AND COMMODITY EXHIBITING SYSTEM”, the entire contents of which are incorporated herein by reference.

### TECHNICAL FIELD

The disclosure generally relates to the technical field of internet of things, in particular to a commodity marking method, a commodity exhibiting method, a server, a terminal, and a commodity exhibiting method.

### BACKGROUND

With the continuous development of society and economy, the level of productivity is gradually improving, the category of commodity that people can buy is also greatly increased. While the supermarkets and the convenience stores and so forth provide great convenience to satisfy people's shopping needs. Generally, in such markets or stores, the store clerk needs to adjust the positions and types of goods displayed on the shelf according to seasonal changes and consumer preferences in supermarkets and convenience stores.

At present, firstly, the store clerk obtains the template data which includes a schedule plan of items planned to be displayed in each position of the shelf. Secondly, the template data is compared artificially with the commodities actually displayed at various locations of the shelf, to determine the difference between the commodities scheduled to be displayed and the items actual displayed, which is used to determine whether the commodities actually displayed in each position of the shelf meet the requirements of the schedule plan. When it does not meet the requirements, the commodities actually displayed in each position of the shelf will be adjusted based on the template data.

### SUMMARY

The disclosure provides a commodity marking method, a commodity exhibiting method, a server, a terminal, and a commodity exhibiting method.

The disclosure provides a commodity marking method, applied in a server, comprises:

receiving at least one piece of template data sent by a first terminal and at least one piece of collecting data sent by a second terminal;

determining target template data from the at least one piece of template data, and determining target collecting data from the at least one piece of collecting data; the target template data comprise at least one first shelf identifier corresponding to a first shelf, each of the at least one first shelf comprises a plurality of first locations that are capable of storing commodity, the target collecting data comprise at least one second shelf identifier corresponding to a second shelf, each of the at least one second shelf comprises a plurality of second locations that are capable of storing commodity;

comparing the target template data with the target collecting data and marking a difference in location, to obtain a commodity marking result of the at least one first shelf and the at least one second shelf; and

sending the commodity marking result to a third terminal.

Optionally, wherein the target template data further comprises a location identifier corresponding to each of the first locations and first commodity status at each of the first locations; and

the target collecting data further comprise a location identifier corresponding to each of the second locations, and second commodity status at each of the second locations.

Optionally, wherein the step of comparing the target template data with the target collecting data and marking a difference in location, to obtain the commodity marking result of the at least one first shelf and the at least one second shelf, comprises:

determining whether a second shelf identifier which is consistent with a target shelf identifier exists in the target collecting data; wherein the target shelf identifier is any one of the first shelf identifiers;

on the condition that the second shelf identifier which is consistent with the target shelf identifier exists in the target collecting data, determining whether the first target commodity status is consistent with the second target commodity status;

wherein, the first target commodity status refers to the first commodity status at a first target location in the first shelf corresponding to the target shelf identifier, the second target commodity status refers to the second commodity status at a second target location in the second shelf corresponding to the target shelf identifier, the first target location and the second target location have a same location identifier, the first target location is any one of the first locations, and the second target location is any one of the second locations; and

adding a first marking result to the second target commodity status, on the condition that the first target commodity status is inconsistent with the second target commodity status.

Optionally, wherein after the step of determining whether the first target commodity status is consistent with the second target commodity status, the method further comprises:

adding a second marking result to the second target commodity status, on the condition that the first target commodity status is consistent with the second target commodity status; the second marking result is a commodity unchanged mark.

Optionally, wherein the first commodity status comprises the status of commodities displayed at the first location, and the status of no commodities displayed at the first location; the second commodity status comprises the status of commodities displayed at the second location, and the status of no commodities displayed at the second location; and

the first marking result comprises a commodity addition mark, a commodity off-shelf mark and a commodity replacing mark.

Optionally, wherein the step of adding a first marking result to the second target commodity status, on the condition that the first target commodity status is inconsistent with the second target commodity status, comprises:

adding the commodity addition mark to the second target commodity status, on the condition that commodities displayed at the first target location and no commodities displayed at the second target location, and adding a commodity category needed to be added to the second target commodity status according to the commodities displayed at the first target location;

adding the commodity off-shelf mark to the second target commodity status, on the condition that no commodities displayed at the first target location and commodities displayed at the second target location; and

adding the commodity replacing mark to the second target commodity status, on the condition that commodities displayed at both of the first target location and the second target location, and the commodity categories of the commodities displayed at the first target location and the second target location are different, and adding a replaced commodity category to the second target commodity status according to the commodities displayed at the first target location.

Optionally, wherein after the step of determining whether a second shelf identifier which is consistent with a target shelf identifier exists in the target collecting data the method further comprises:

on the condition that a third shelf identifier which is not comprised by the target collecting data exists in the target template data, adding a third marking result to the target collecting data according to the third commodity status of each third location of each third shelf corresponding to each of third shelf; and

wherein the third marking result comprises a shelf addition mark corresponding to a fourth shelf identifier, the commodity addition marks and the commodity categories needed to be added to a fourth commodity status at each fourth location of each of fourth shelf corresponding to the fourth shelf identifier, wherein the fourth shelf identifier is consistent with the third shelf identifier.

Optionally, wherein after the step of determining whether the second shelf identifier which is consistent with the target shelf identifier exists in the target collecting data the method further comprises:

adding a fourth marking result to the target collecting data on the condition that a fifth shelf identifier which is not comprised by the target template data exists in the target collecting data; and

the fourth marking result comprises a shelf deletion mark corresponding to the fifth shelf identifier, and a commodity off-shelf mark added to the fifth commodity status at each fifth location of each of the fifth shelf corresponding to the fifth shelf identifier.

Optionally, wherein, each piece of the template data comprises a first timestamp, each piece of the collecting data comprises a second timestamp;

the step of determining the target template data from the at least one piece of template data, and determining the target collecting data from the at least one piece of collecting data, comprises:

determining the collecting data which is corresponding to the second timestamp closest to a target time point as the target collecting data; and

determining the template data which is corresponding to the first timestamp matched to the second timestamp comprised in the target collecting data as the target template data.

Optionally, wherein the method is applied to a terminal, and the method comprises:

receiving a commodity marking result sent from a server;

wherein the commodity marking result refers to the result obtained by comparing and marking of target template data and target collecting data, wherein, the target template data comprise at least one first shelf identifier corresponding to a first shelf, each of the at least one first shelf comprises a plurality of first locations that are capable of storing commodity, and the target collecting data comprise at least one second shelf identifier corresponding to a second shelf, each of the at least one second shelf comprises a plurality of second locations that are capable of storing commodity; and

exhibiting the commodity marking result.

Optionally, wherein the step of exhibiting the commodity marking result, comprises:

displaying the marking result of each position in a specified shelf on a shelf interface;

wherein, the marking result comprises a commodity addition mark, a commodity off-shelf mark, a commodity replacing mark and a commodity unchanged mark, the specified shelf is any one shelf of a second shelf, a fourth shelf or a fifth shelf.

Optionally, wherein, the shelf interface further displays marking information of other shelves other than the specified shelf, the marking information comprises a quantity of positions that the commodity needed to be replaced in other shelves other than the specified shelf.

Optionally, wherein other marks other than the commodity unchanged mark in the marking result, and the commodity unchanged mark, are displayed at the corresponding position in the shelf interface with different display effects; and

wherein, the display effect comprises one or more of a display color, a display pattern and a background hatch pattern.

Optionally, wherein after displaying the marking result of each position in specified shelf on the shelf interface, the method further comprises:

receiving a user's selecting operation to a specified area of the specified shelf in the shelf interface;

displaying a commodity marking interface corresponding to a position of the specified area according to the selecting operation; and

wherein, the commodity marking interface comprises the commodity category and a mark pattern corresponding to the marking result, the commodity category comprises a commodity name and/or a commodity identifier.

The disclosure further discloses a server, wherein the server comprises a processor, a memory, and a computer program stored on the memory and the computer program is executed by the processor to implement the steps of the commodity marking method as mentioned above.

The disclosure further discloses a terminal, wherein the terminal comprises a processor, a memory, and a computer program stored on the memory and the computer program is executed by the processor to implement the steps of the commodity exhibiting method as mentioned above.

The disclosure further discloses a computer readable storage medium, wherein the computer program is stored on the computer readable storage medium and the computer program is executed by the processor to implement the steps of the commodity marking method or the commodity exhibiting method as mentioned above

The disclosure further discloses a commodity exhibiting method, wherein the system comprises the server and the terminal as mentioned above, wherein the terminal refers to the third terminal.

Optionally, wherein the system further comprises the first terminal and the second terminal;

the first terminal is configured to send at least one piece of the template data to the serve;

and

the second terminal is configured to collect and send at least one piece of the collecting data to the server.

Optionally, wherein the server is configured to:

receiving at least one piece of the template data sent by the first terminal, and at least one piece of the collecting data sent by the second terminal;

determining target template data from at least one piece of template data, and determining the target collecting data from at least one piece of the collecting data; the target template data comprises at least one first shelf identifier corresponding to a first shelf, each of the at least one first shelf comprises a plurality of first locations that are capable of storing commodity, the target collecting data comprise at least one second shelf identifier corresponding to a second shelf, each of the at least one second shelf comprises a plurality of second locations that are capable of storing commodity; and

comparing the target template data with the target collecting data and marking the differences in locations, to obtain the commodity marking result of the at least one first shelf and the at least one second shelf; and

sending the commodity marking result to the third terminal.

Optionally, wherein, the third terminal is configured to:

receiving the commodity marking result sent by the server;

wherein the commodity marking result refers to the result obtained by comparing and marking of the target template data and target collecting data, wherein, the target template data comprises at least one first shelf identifier corresponding to a first shelf, each of the at least one first shelf comprises a plurality of first locations that are capable of storing commodity, and the target collecting data comprise at least one second shelf identifier corresponding to a second shelf, each of the at least one second shelf comprises a plurality of second locations that are capable of storing commodity; and

exhibiting the commodity marking result.

The disclosure further discloses a computer program, comprising a computer readable code, when the computer readable code operates on the display apparatus, the display apparatus executes the commodity marking method or the commodity exhibiting method as mentioned above.

The disclosure further provides a computer program, comprising a computer readable code, when the computer readable code operates on the display apparatus, the display apparatus executes the commodity marking method or the commodity exhibiting method.

The above description is only an overview of the technical scheme of the disclosure. In order to better understand the technical means of the disclosure, the implementation can be carried out in accordance with the contents of the manual, and in order to make the aforesaid and other purposes, features and advantages of the disclosure more obvious and understandable, the specified implementation methods of the disclosure are given below.

### BRIEF DESCRIPTION OF THE DRAWINGS

In order to more clearly illustrate the technical solutions of the embodiments of the present application or the prior art, the figures that are required to describe the embodiments or the prior art will be briefly introduced below. Apparently, the figures that are described below are embodiments of the present application, and a person skilled in the art can obtain other figures according to these figures without paying creative work.

FIG. 1 illustrates a flow chart of a commodity marking method of the embodiment of the disclosure;

FIG. 2 illustrates an architecture diagram of a commodity marking method of the embodiment of the disclosure;

FIG. 3 illustrates a specified flow chart of a commodity marking method of the embodiment of the disclosure;

FIG. 4 illustrates a flow chart of a commodity exhibiting method of the embodiment of the disclosure;

FIG. 5 illustrates a schematic diagram of shelf interface of the embodiment of the disclosure;

FIG. 6 illustrates a schematic diagram of the first type of commodity marking interface of the embodiment of the disclosure;

FIG. 7 illustrates a schematic diagram of the second type of commodity marking interface of the embodiment of the disclosure;

FIG. 8 illustrates a schematic diagram of the third type of commodity marking interface of the embodiment of the disclosure;

FIG. 9 illustrates a block diagram of the computing processing device used to execute the method according to the disclosure; and

FIG. 10 illustrates a storage unit used to maintain or carry the program code for achieving the method according to the disclosure.

### DETAILED DESCRIPTION OF THE EMBODIMENTS

In order to make the objects, the technical solutions and the advantages of the embodiments of the present disclosure clearer, the technical solutions of the embodiments of the present disclosure will be clearly and completely described below with reference to the drawings of the embodiments of the present disclosure.

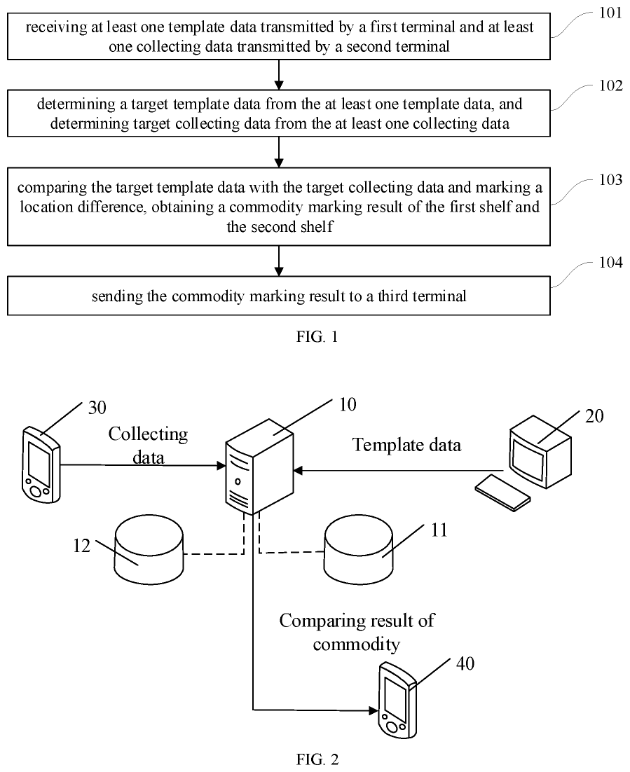

Referring to FIG. 1, which illustrates a flowchart of a commodity marking method of this embodiment of the disclosure, the method is applied in the server, which includes the following steps:

Step 101: receiving at least one piece of template data send by a first terminal and at least one piece of collecting data send by a second terminal.

In this embodiment of the disclosure, a store clerk may collect information of commodity that actually displayed on a shelf in the store through a second terminal, and the information of commodity actually displayed on the shelf in the store is collecting data. Wherein, the collecting data include the commodity categories that are actually displayed, the locations of the commodities that are actually displayed, and the relationships between the commodity locations and a second shelf.

Specifically, the information of commodity actually displayed on the shelf may be manually entered on the second terminal; or, obtaining the information of commodity which are actually displayed on the shelf by identifying pictures collected by the cameras of the second terminal, while the pictures contain the information of commodity which are actually displayed on the shelf. Then the store clerk may check whether the identified information of commodity is wrong, when it is wrong, the store clerk may adjust the information of commodity manually.

The template designer may design the information of commodity planned to be displayed on the shelf on a first terminal according to the practical situation to obtain template data. Wherein, the template data includes the commodity categories planned to be displayed, the positions of the commodities planned to be displayed, and the relationships between the commodity positions and the first shelf.

As referring to FIG. 2, after the template data are obtained by a first terminal 20, the template data may be sent to a server 10. The collecting data may be also sent to the server 10 after the collecting data collected by a second terminal 30. The server 10 receives the template data sent by the first terminal 20 and the collecting data sent by the second terminal 30, and then, the server 10 stores the template data sent by the first terminal 20 in a first database 11 in the server 10, and stores the collecting data sent by the second terminal 30 in a second database 12 in the server 10.

It should be noted that, the template data needs to be updated according to practical needs. For example, the update period is one week, so the server 10 receives at least one piece of template data sent by the first terminal 20; accordingly, the collecting data in the second terminal 30 also needs to be updated according to practical situation. Therefore, the server 10 receives at least one piece of collecting data from the second terminal 30.

Step 102: determining a piece of target template data from the at least one piece of template data, and determining the target collecting data from the at least one piece of collecting data;

In this embodiment of the disclosure, after receiving the at least one piece of template data sent by the first terminal 20 and the at least one piece of collecting data sent by the second terminal 30, according to practical needs, the target template data is determined from at least one piece of template data, and target collecting data is determined from the at least one piece of collecting data. Then, the target template data are read from the first database 11 and the target collecting data are read from the second database 12.

Wherein, the target template data includes at least one first shelf identifier corresponding to a first shelf, each of the first shelves includes a plurality of first locations that are capable of storing commodities, the target collecting data includes a second shelf identifier corresponding to a at least one second shelf, each of the second shelves includes a plurality of second locations that are capable of storing commodities;

There is a unique first shelf identifier corresponding to each of the first shelves, and the first shelf identifiers corresponding to any two of the first shelves are different. Correspondingly, there is a unique second shelf identifier corresponding to each of the second shelves, and the second shelf identifiers corresponding to any two of the second shelves are different.

It should be noted that, when the first shelf identifier is the consistent with the second shelf identifier, the corresponding first shelf and second shelf are actually the same shelf. Naming of the first shelf and the second shelf is just to distinguish the shelf corresponding to the first shelf identifier in the target template data and the shelf corresponding to the second shelf identifier in the target collecting data.

Step 103: comparing the target template data with the target collecting data and marking a difference in location, to obtain a commodity marking result of the first shelf and the second shelf.

In this embodiment of the disclosure, after determining of the target template data and the target collecting data, the target template data is compared with the target collecting data. It is basically a comparison between relationships, which are the relationship between the commodity categories actually displayed, the commodity locations actually displayed and the commodity locations to the second shelf, and the relationship between the commodity categories planned to be displayed, the commodity locations planned to be displayed and the commodity locations to the first shelf, to obtain the commodity marking result of the first shelf and the second shelf.

It should be noted that, when the target template data is compared with the target collecting data, the difference between the target template data and the target template data may be marked directly in the target collecting data, to generate the commodity marking results of the first shelf and the second shelf, which is marked target collecting data; or, when the target template data is compared with the target collecting data, the difference between the target collecting data and the target collecting data is marked and stored in a comparison document separately, to generate the commodity marking results of the first shelf and the second shelf, which is the comparison document for storing the commodity marking results.

Step 104: sending the commodity marking result to a third terminal.

In this embodiment of the disclosure, as referring to FIG. 2, after obtaining of the commodity results of the first shelf and the second shelf by comparing, the server 10 sends the commodity marking results to a third terminal 40, and the store clerk may review the commodity marking result on the third terminal 40 directly and adjust the commodity displayed on the shelf quickly according to the commodity marking results.

It should be noted that, the third terminal 40 and the second terminal 30 may be different terminals or the same terminal. For example, the store clerk A holding the second terminal 30 is responsible for the collection of the commodity information actually displayed on shelf and send the commodity marking results to the third terminal 40 held by the other store clerk B who is responsible for sorting the commodities, or the same store clerk holding a terminal may be responsible for collecting the information of the commodities actually displayed on the shelf and receiving the comparison results to sort the commodities. This embodiment of the disclosure does not specify this.

In this embodiment of the disclosure, the commodity marking results of the shelf in the target template data and target collecting data are obtained by sending both of the target template data and the target collecting data to a server and comparing the target template data and the target collecting data in the server, After that, the commodity marking results of the shelf are sent to the third terminal from the server, and a store clerk may review the commodity marking results on a third terminal directly and adjust the commodities displayed on the shelf according to the commodity marking results quickly. It is not only saving the time spent on commodities sorting of the store clerk and improving the efficiency of commodities sorting, but also reducing the difficulty of commodities sorting.

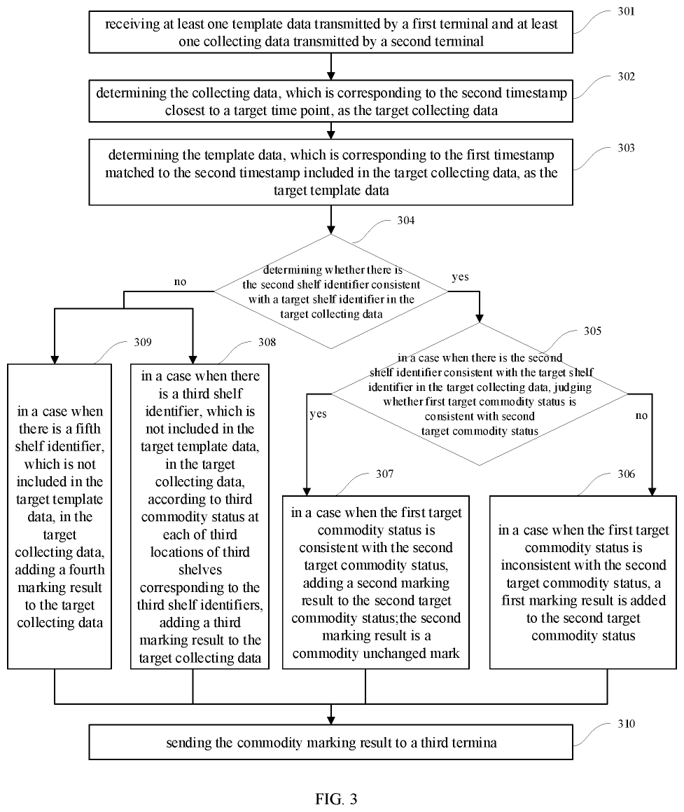

Referring to FIG. 3, which illustrates a flowchart of a commodity marking method of this embodiment of the disclosure, the method is applied in the server, which includes the following steps:

Step 301: receiving at least one piece of template data send by a first terminal and at least one piece of collecting data send by a second terminal.

The principle of this step is similar to that of the step 101 aforementioned embodiments without more depiction.

Step 302: determining the target collecting data, which is the collecting data corresponding to a second timestamp closest to a target time.

In this embodiment of the disclosure, when the first terminal sends the template data to the server, each piece of the template data includes a first timestamp, and when the second terminal sends the collecting data to the server, each piece of the collecting data includes a second timestamp.

The time difference between the target time and the second timestamp corresponding to each piece of the collecting data is sequentially determined, and the collecting data with the smallest time difference is selected, that is, the collecting data corresponding to the second timestamp closest to the target time point is determined as the target collecting data.

Wherein, the target time may be the current time or any time selected by the store clerk. When it is necessary to compare the target template data with the target collecting data, a comparison instruction carrying the target time may be sent to the server by the second terminal.

For example, the target time is 2020-03-10, the collecting data in the server includes collecting data 1, collecting data2, and collecting data3, the second timestamp of collecting data 1 is 2020-02-24, the second timestamp of collecting data 2 is 2020-03-02, the second timestamp of collecting data 3 is 2020-03-09, and the second timestamp of collecting data 3 is the closest to the target time point. Therefore, collecting data 3 is determined as the target collecting data.

It should be noted that, the store number is used as the unit to compare the commodity marking results of every store in the embodiment of the present disclosure. Therefore, when it is necessary to determine the target collecting data, the target collecting data is determined from the at least one piece of collecting data corresponding to the store number.

Step 303: determining the target template data, which is the template data corresponding to the first timestamp matched to the second timestamp included in the target collecting data.

In this embodiment of the disclosure, after determining of the target collecting data, the second timestamp of the target collecting data is compared with the first timestamp of each piece of the template data, the template data corresponding to the first timestamp that matches the second timestamp included in the target collecting data is determined as the target template data.

For example, the template data in the server includes template data 1, template data 2, and template data 3. The first timestamp of template data 1 is from 2020-02-23 to 2020-02-29, and the first timestamp of template data 2 is from 2020-03-01 to 2020-03-07, the first timestamp of template data 3 is from 2020-03-08 to 2020-03-14, the second timestamp included in target collecting data is 2020-03-09, and the second timestamp 2020-03-09 is between 2020-03-08 and 2020-03-14, it is determined that the template data corresponding to the first timestamp matched to the second timestamp 2020-03-09 is the template data 3, and template data 3 is determined as the target template data.

Step 304: determining whether the second shelf identifier consistent with a target shelf identifier exists in the target collecting data.

In this embodiment of the disclosure, the target template data include at least one first shelf identifier corresponding to a first shelf, and each of the first shelves includes a plurality of first locations that are capable of storing commodity; the target collecting data include a second shelf identifier corresponding to the at least one second shelf, and each of the second shelves includes a plurality of the second locations that are capable of storing commodity. In addition, the target template data further include the location identifier corresponding to each of the first locations and the first commodity status at each of the first locations; the target collecting data further include the location identifiers corresponding to each of the second locations and the second commodity status of each of the second locations.

Each of the first locations in the first shelf has its unique location identifier, and the location identifiers corresponding to any two of the first locations in the first shelf are different; each of the second locations in the second shelf also has its unique location identifier, the location identifiers corresponding to any two of the second locations in the second shelf are also different.

A first shelf identifier is selected randomly from the target template data as the target shelf identifier, that is, the target shelf identifier is any one of the first shelf identifiers, and it is determined whether there is the second shelf identifier consistent with the target shelf identifier in the target collecting data.

For example, the target shelf identifier is M1, and the second shelf identifiers included in the target collecting data are second shelf identifier M1, second shelf identifier M2, second shelf identifier M3, and second shelf identifier M4. It may be seen by determining of whether there is a second shelf identifier consistent with target shelf identifier M1 in the target collecting data, that if the second shelf identifier M1 in the target collecting data is consistent with the target shelf identifier M1, it is then determined that there is a second shelf identifier consistent with the target shelf identifier in the target collecting data.

When there is a second shelf identifier consistent with the target shelf identifier in the target collecting data, that is, when there is the same shelf identifier in the target collecting data and the target template data, step 305 to step 307 may be executed for the same shelf identifier, which is the target shelf identifier. Other first shelves in the target template data may selected subsequently as the target shelf identifiers in sequence, to compare with the second shelf identifier in the target collecting data. The comparison may be finished until all of the first shelf identifiers in the target template data are compared with the second shelf identifier in the target collecting data. Therefore, after the process of the comparison, there are two situations other than the situation that the second shelf identifier consistent with the target shelf identifier in the target collecting data. The first situation is that a third shelf identifier other than all of the second shelf is included in the target collecting data in the target template data, and executing step 308 at this time. The second situation is that a fifth shelf identifier other than all of the first shelf is included in the target template data in the target collecting data, executing step 309 at this time.

Step 305: determining whether the first target commodity status is consistent with the second target commodity status, on the condition of the second shelf identifier consistent with the target shelf identifier exists in the target collecting data.

In this embodiment of the disclosure, when there is a second shelf identifier consistent with the target shelf identifier in the target collecting data, the consistency of the first target commodity status is determined with the second target commodity status; wherein, the first target commodity status refers to the first commodity status at the first target location in the first shelf corresponding to the target shelf identifier, and the second target commodity status refers to the second commodity status at the second target location in the second shelf corresponding to the target shelf identifier. The first target location and the second target location have the same location identifier, the first target location is any one of the first locations, and the second target location is any one of the second locations.

The first commodity status refers to whether there are commodities displayed at the first target location. When there is a commodity displayed in the first target location, the first commodity status further includes the commodity category of the commodities displayed at the first target location; the second commodity status refers to whether there are commodities displayed at the second target location, when there is a commodity displayed at the second target location, the second commodity status further includes the commodity category of the commodity displayed at the second target location.

For example, when there is a second shelf identifier consistent with target shelf identifier M1 in the target collecting data, the consistency of the first commodity status at the first target location Ma in the first shelf corresponding to the target shelf identifier M1 is determined with the second commodity status at the second target location Mb in the second shelf corresponding to the target shelf identifier M1, the location identifier of the first target location Ma is the same as the location identifier of the second target location Mb.

In practical applications, for the first shelf and second shelf corresponding to the same shelf identifier, each of the first locations in the first shelf corresponds to each one of the second locations in the second shelf, and the location identifier is the same one. For example, the first one of the first locations in the first shelf and the first one of the second locations in the second shelf have the same location identifier, and the second one of the first locations in the first shelf and the second one of the second locations in the second shelf have the same location identifier, the third one of the first locations in the first shelf and the third one of the second locations in the second shelf have the same location identifier, and so on.

Therefore, according to the position order, the first one of the first locations in the first shelf is selected firstly as the first target location, and the first one of the second locations in the second shelf is also selected firstly as the second target location. It is determined whether the first commodity status at the first one of first locations in the first shelf is consistent with the second commodity status at the first one of the second locations in the second shelf; The second one of the first locations in the first shelf is then selected as the first target location, and the second one of the second locations in the second shelf is also then selected as the second target location, it is determined whether the first commodity status of the second one of the first locations in the first shelf consistent with the second commodity status at the second one of the second locations in the second shelf. Next, the third one of the first locations in the first shelf is selected as the first target location, and the third one of the second locations in the second shelf is selected as the second target location. It is determined whether the first commodity status of the third one of the first locations in the first shelf is consistent with the second commodity status of the third one of the second locations in the second shelf, and so on, until the determining of all the first commodity status in the first locations in the first shelf and all the second commodity status in the second locations in the second shelf is completed.

When the first target commodity status is inconsistent with the second target commodity status, step 306 is executed; when the first target commodity status is consistent with the second target commodity status, step 307 is executed.

Step 306: adding a first marking result to the second target commodity status, on the condition that the first target commodity status is inconsistent with the second target commodity status.

In this embodiment of the disclosure, when the first target commodity status is inconsistent with the second target commodity status, that is, when the first commodity status at the first target location in the first shelf corresponding to the target shelf identifier is inconsistent with the second commodity status at the second target location of the second shelf corresponding to the target shelf identifier, it is necessary to replace the commodity displayed at the second target location in the second shelf corresponding to the target shelf identifier. Therefore, the first marking result is added to the second commodity status at the second target location in the second shelf corresponding to the target shelf identifier, that is, the first marking result is added to the second target commodity status. Wherein, the first marking result includes a commodity addition mark, a commodity off-shelf mark and a commodity replacing mark.

The first target commodity status is inconsistent with the second target commodity status. There are usually three situations, the first situation is that there are commodities displayed at the first target location and no commodities displayed at the second target location; the second situation is that there is no commodities display at the first target location and there are commodities displayed at the second target location; and the third situation is that there are commodities displayed at both of the first target location and the second target location, but the commodity categories of the commodities displayed at the first target location and the second target location are different.

Therefore, the step 306 specifically includes sub-step S11, sub-step S12, and sub-step S13:

sub-step S11: in the condition of when there are commodities displayed at the first target location and there is no commodity displayed at the second target location, adding the commodity addition mark to the second target commodity status, and according to the commodities displayed at the first target location, adding a commodity category needed to be added to the second target commodity status.

sub-step S12: in the condition of when there are no commodities displayed at the first target location and there are commodities displayed at the second target location, adding the commodity off-shelf mark to the second target commodity status

sub-step S13: in the condition of when there are commodities displayed both at the first target location and the second target location, and when the commodity category of the commodities displayed at the first target location and the second target location is different, adding the commodity replacing mark to the second target commodity status, and according to the commodities displayed at the first target location, adding a replaced commodity category to the second target commodity status

In this embodiment of the disclosure, the first commodity status includes a first display status and a first non-display status. When the first commodity status is the first display status, there are commodities displayed at the first location. When the first commodity status is the first non-display status, there is no commodity displayed at the first location; the second commodity status includes the second display status and the second non-display status. When the second commodity status is the second display status, there are commodities displayed at the second location. When the second commodity status is the second non-display status, there is no commodity displayed at the second location.

Therefore, in the first situation, the first commodity status at the first target location is the first display status, and the second commodity status at the second target location is the second non-display status, that is, there are commodities displayed at the first target location, and there is no commodity displayed at the second target location. At this time, it is necessary to add commodities at the second target location in the second shelf corresponding to the target shelf identifier, that is, the commodity addition mark is added to the second target commodity status, and the commodity category needs to be added is added to the second target commodity status according to the commodities displayed at the first target location in the first shelf corresponding to the target shelf identifier. The commodities that are consistent with the commodities displayed at the first target location are added to the second target location in the second shelf corresponding to the target shelf identifier. Wherein, the commodity category includes a commodity name and/or a commodity identifier.

For example, the target shelf identifier is 12000A5B, and the first target location is the sixth position of the first floor in the first shelf corresponding to the target shelf identifier 12000A5B, the second target location is the sixth location on the first floor in the second shelf corresponding to the target shelf identifier 12000A5B. There are commodities displayed at the sixth position on the first floor of the first shelf, and no commodities displayed at the sixth position on the first floor in the second shelf. In addition, the commodity name of the commodity displayed at the sixth position on the first floor of the first shelf is “Strawberry gum” with the commodity identifier “1234567890”. The commodity addition mark is added to the second commodity status at the sixth position of the first floor in the second shelf corresponding to the target shelf identifier 12000A5B. And according to the commodities displayed at the sixth position of the first floor of the first shelf corresponding to target shelf identifier 12000A5B, the commodity category that needs to be added is added to the second commodity status at the sixth position of the first floor of the second shelf corresponding to the target shelf identifier 12000A5B. When the commodity category only includes the commodity name, only the commodity name “Strawberry flavor chewing gum” needs to be added. When the commodity category only includes the commodity identifier, only the commodity identifier “1234567890” needs to be added. When the commodity category includes a commodity name and a commodity identifier, the commodity name “Strawberry gum” with the commodity identifier “1234567890” need to be added at the same time.

The second situation: the first commodity status at the first target location is first non-display status, and the second commodity status at the second target location is second display status, that is, there is no commodity displayed at the first target location, and there are commodities at the second target location, at this time, it is need to remove the commodities at the second target location in the second shelf corresponding to the target shelf identifier, that is, the commodity off-shelf mark is added to the second target commodity status. Certainly, the commodity category that needs to be removed is added to the second target commodity status according to the commodities originally displayed at the second target location.

For example, the target shelf identifier is 12000A5B, the first target location is the seventh position of the second floor in the first shelf corresponding to target shelf identifier 12000A5B, and the second target location is the seventh position of the second floor in the second shelf corresponding to target shelf identifier 12000A5B. There is no commodity displayed at the seventh position of the second floor in the first shelf and there are commodities displayed at the seventh position of the second shelf in the second shelf. In addition, the name of the commodity originally displayed at the seventh position of the second floor in the second shelf is “AA face clean cream” with the commodity identifier “1234567891”. The commodity off-shelf mark is added to the second floor of the second shelf corresponding to target shelf identifier 12000A5B in the target collecting data, and the commodity category that needs to be removed may be added at the same time to the second commodity status at the seventh position on the second floor of the second shelf corresponding to the target shelf identifier 12000A5B. That is, the commodity category that needs to be removed includes the commodity name “AA face clean cream” and/or the commodity identifier “1234567891”.

The third situation is that the first commodity status at the first target location is the first display status, and the second commodity status at the second target location is the second display status. That is, there are commodities displayed at both the first target location and the second target location. However, the commodities displayed at the first target location and the second target location have different commodity categories. At this time, it is necessary to replace the commodities at the second target location in the second shelf corresponding to the target shelf identifier, that is, the commodity replacing mark is added to the second target commodity status. And according to the commodities displayed at the first target location, the replaced commodity category is added in the second target commodity status. That is, according to the commodities displayed at the first target location in the first shelf corresponding to the target shelf identifier, the commodities originally displayed at the second target location in the second shelf corresponding to the target shelf identifier is replaced with the commodities displayed at the first target location.

For example, target shelf identifier is 12000A5B, the first target location is the forth position of the third floor in the first shelf corresponding to the target shelf identifier12000A5B, the second target location is the forth position of the third floor in the second shelf corresponding to the target shelf identifier12000A5B, there are commodities at the forth position of the third floor in the first shelf, and there are commodities at the forth position of the third floor in the second shelf. However, the commodity name of the commodity displayed at the fourth position on the third floor of the first shelf is “XX Cola” with the commodity identifier “1234567892”, and the name of the commodity displayed at the fourth position on the third floor of the second shelf is “YY Cola” with the commodity identifier “1234567893”. Then in the target collecting data, the commodity replacing mark is added in the second commodity status of the fourth position of the third floor in the second shelf corresponding to the target shelf identifier 12000A5B. And according to the commodities replayed at the fourth position of the third floor in the first shelf corresponding to target shelf identifier 12000A5B, the replaced commodity category is added in the second commodity status at the fourth position of the third floor in the second shelf corresponding to target shelf identifier 12000A5B, that is, the commodity name “YY Cola” with the commodity identifier “1234567893” originally displayed at the fourth position on the third floor of the second shelf, is replaced with a commodity name of “XX Coke” with the commodity identifier “1234567892”. That is, the replaced commodity category includes the commodity name “XX Cola” and/or the commodity identifier “1234567892”.

Step 307: on the condition that the first target commodity status is consistent with the second target commodity status; the second marking result is a commodity unchanged mark.

In this embodiment of the disclosure, when the first target commodity status is consistent with the second target commodity status, that is, when the first commodity status at the first target location in the first shelf corresponding to the target shelf identifier is consistent with the second commodity status at the second target location in the second shelf corresponding to the target shelf identifier, it is not necessary to replace the commodities displayed at the second target location in the second shelf corresponding to the target shelf identifier. Therefore, the second marking result is added to the second commodity status at the second target location in the second shelf corresponding to the target shelf identifier, that is, the second marking result is the commodity unchanged mark according to the second marking result of the second target commodity status.

For example, the target shelf identifier is 12000A5B, the first target location is the first location of the first floor of the first shelf corresponding to the target shelf identifier 12000A5B, the second target location is the first location of the first floor of the second shelf corresponding to the target shelf identifier 12000A5B. There are commodities at the first location of the first floor of the first shelf, there are commodities at the first location of the first floor of the second shelf, and the name of the commodities displayed at the first location of the first floor of the first shelf, and the name of the commodities displayed at the first location of the first floor of the second shelf are both “Strawberry gum”, the commodity identifiers are both “1234567890”.

Then in the target collecting data, the commodity unchanged mark is added in the second commodity status at the first location of the first floor of the second shelf corresponding to the target shelf identifier 12000A5B.

Step 308: adding a third marking result to the target collecting data, in the condition of that a third shelf identifier which is not included in the target collecting data exists, in the target template data, according to the third commodity status at each of the third locations of each of the third shelf corresponding to the third shelf identifiers.

In this embodiment of the disclosure, when all of the first shelf identifier in the target template data and all of the second shelf identifier in the target collecting data are compared completely, it may be found that there is the first shelf identifier other than all of the second shelf identifier included in the target collecting data in the target template data, the first shelf identifier other than all of the second shelf identifiers included in the target collecting data is then determined as the third shelf identifier in the target template data. At this time, it is necessary to add new shelf to the target collecting data, and it is necessary to add new commodities to each of the positions on the new shelf, that is, the third marking result is added to the target collecting data, wherein, the third marking result includes the shelf addition mark corresponding the fourth shelf identifier, and according to the third commodity status of each of the third locations in each of the third shelf corresponding to the third shelf identifiers, the commodity addition mark and the commodity category that need to be added are added to the fourth commodity status at the fourth locations in the fourth shelf corresponding to the fourth shelf identifiers, the fourth shelf identifiers are consistent with the third shelf identifiers.

It should be noted that, the fourth shelf is a new shelf, and the fourth shelf identifier corresponding to the fourth shelf is consistent with the third shelf identifier, and the shelf addition mark corresponding to the fourth shelf identifier needs to be added in the target collecting data; and it is necessary to determine the fourth commodity status at the locations of each of the fourth shelf on the fourth shelf, according to the third commodity status at each third location in the third shelf corresponding to the third shelf identifier. Therefore, the commodity addition mark and the commodity category need to be added are added in the fourth commodity status at each of the fourth locations of the fourth shelf in the target collecting data.

In addition, the third shelf identifier is actually still the first shelf identifier in the target template data, but there is no second shelf identifier that is consistent with this first shelf identifier in the target collecting data.

When there are third commodities at all of the third locations in the third shelf corresponding to the third shelf identifier, it is then necessary to add the commodity addition mark in the fourth commodity status at all of the fourth locations of the fourth shelf.

For example, the second shelf identifier included in the target collecting data are second shelf identifier M1, second shelf identifier M2, second shelf identifier M3 and second shelf identifier M4, the first shelf identifier included in the target template data are first shelf identifier M1, first shelf identifier M2, first shelf identifier M3 and first shelf identifier M5. The first shelf identifier M5 in the target template data is determined as the third shelf identifier, therefore, it is need to add the shelf addition mark corresponding to the fourth shelf identifier consistent with the third shelf identifier M5 in the target collecting data, and the commodity addition mark and the commodity category needed to be added are added in the fourth commodity status, which at the fourth location in the fourth shelf corresponding to the fourth shelf identifier that is consistent with the third shelf identifier M5.

Step 309: adding a fourth marking result to the target collecting data, in the condition of that a fifth shelf identifier is not included in the target template data exists in the target collecting data.

In this embodiment of the disclosure, when the first shelf identifier in the target template data and the second shelf identifier in the target collecting data are all compared, it may be found that there is second shelf identifier other than all of the first shelf identifiers included in the target template data in the target collecting data, the second shelf identifier other than all of the first shelf identifiers included in the target template data in the target collecting data is determined as the fifth shelf identifier. At this time, it is need to the remove the data of the unnecessary shelf from the target collecting data, and the commodities originally displayed at each one of the positions on the unnecessary shelf are also need to be removed, that is, the fourth marking result is added to the target collecting data, wherein, the fourth marking result includes the shelf deletion mark corresponding to the fifth shelf identifier, and the commodity off-shelf mark added in the fifth commodity status at each fifth location in the fifth shelf corresponding to the fifth shelf identifier.

It should be noted that, the fifth shelf is the unnecessary shelf that needs to be removed. The shelf deletion mark corresponding to the fifth shelf identifier needs to be added in the target collecting data. In addition, it is also necessary to add the commodity off-shelf mark in the fifth commodity status at each fifth location in the fifth shelf in the target collecting data. The commodity category needs to be removed is also able to be added.

In addition, the fifth shelf identifier is actually the second shelf identifier in the target collecting data, but the first shelf identifier that is consistent with this second shelf identifier does not exist in the target template data.

When the fifth commodity is displayed in all of the fifth locations in the fifth shelf corresponding to the fifth shelf identifier, it is necessary to add a commodity off-shelf mark in the fifth commodity status at all of the fifth locations in the fifth shelf.

For example, the second shelf identifiers included in target collecting data are second shelf identifier M1, second shelf identifier M2, second shelf identifier M3, and second shelf identifier M4, and the first shelf identifiers included in target template data are first shelf identifier M1, first shelf identifier M2, first shelf identifier M3, and first shelf identifier M5. The second shelf identifier M4 in the target collecting data is determined as the fifth shelf identifier. Therefore, it is necessary to add the shelf deletion mark corresponding to the fifth shelf identifier M4 in the target collecting data, and the commodity off-shelf mark is added in the fifth commodity status of each of the fifth locations in the fifth shelf corresponding to the fifth shelf identifier M4.

Step 310: sending the commodity marking result to a third terminal.

In this embodiment of the disclosure, the commodity marking results of the first shelf and the second shelf actually include the first marking result obtained by step 306, the second marking result obtained by step 307, the third marking result obtained by step 308 and the fourth marking result obtained by step 309, the commodity marking results of the first shelf and the second shelf are send to the third terminal from the server to display the commodity marking results on the third terminal.

In this embodiment of the disclosure, by sending both of the target template data and target collecting data to the server, it is determined whether there is the same target shelf identifier in the target template data and target collecting data. When there is the same target shelf identifier in the target template data and target collecting data, then it is determined whether the commodity status at each of the positions in the first shelf corresponding to the target shelf identifier is consistent with the commodity status at each of the positions in the second shelf corresponding to the target shelf identifier, the different marking results is added according to the commodity status at each of the locations. When there are third shelf identifiers other than all of the second shelf identifiers included in the target collecting data in the target template data, the shelf addition mark and the commodities added at each of the locations of the new shelf are added to the target collecting data. When there are fifth shelf identifiers other than all of the first shelf identifiers included in the target template data in the target collecting data, the shelf deletion mark corresponding to fifth shelf identifier is added in target collecting data, and the commodity off-shelf mark is added in the fifth commodity status at each of the fifth locations of the fifth shelf. Finally, the commodity marking results of the shelf in the target template data and the target collecting data are sent to the third terminal. The store clerk may review the commodity marking result on the third terminal directly and adjust the commodities displayed on the shelf quickly according to the commodity marking result. It is saving the time spent by store clerk, improving the efficiency for sorting commodity, and reducing the difficulty of commodity sorting.

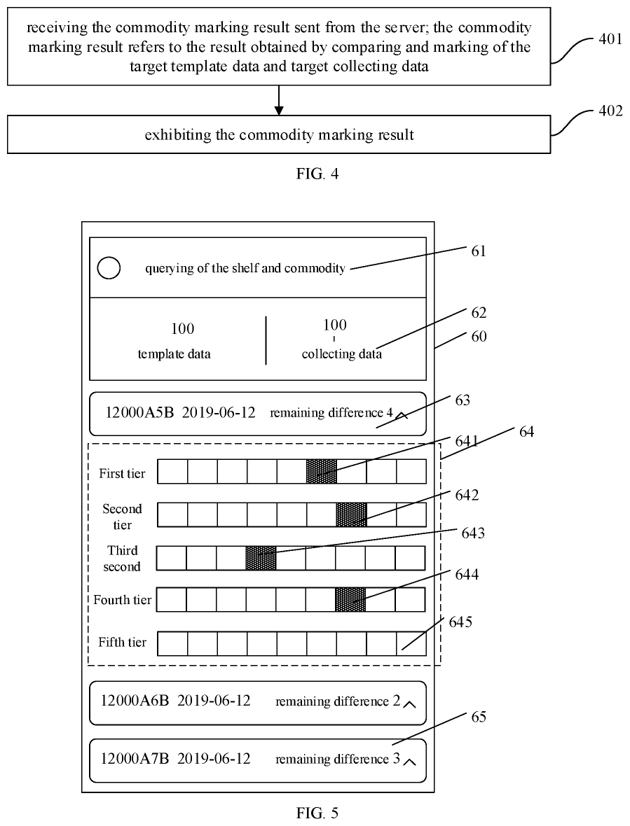

Referring to FIG. 4, which illustrates a flowchart of a commodity exhibiting method of this embodiment of the disclosure, which includes the following steps:

Step 401: receiving the commodity marking result sent from the server; the commodity marking result refers to the result obtained by comparing and marking of the target template data and target collecting data.

In this embodiment of the disclosure, the server receives the at least one piece of template data sent by the first terminal and the at least one piece of collecting data sent by the second terminal, the target template data is determined from the at least one piece of template data, and the target collecting data is determined from the at least one piece of collecting data. Then, the target template data and the target collecting data are compared to obtain the commodity marking results of first shelf and second shelf. Finally, the server sends the commodity marking result to the third terminal, and the third terminal receives the commodity marking results of the first shelf and the second shelf sent by the server, and the commodity marking result is the result according to the comparing of the target template data and target collecting data.

Wherein, the target template data includes at least one first shelf identifier corresponding to a first shelf, each first shelf includes a plurality of first locations that are capable of storing commodity, and the target collecting data includes a second shelf identifier corresponding to the at least one second shelf, and each second shelf includes a plurality of second locations that are capable of storing commodity.

The description for the comparison process of target template data and target collecting data may be refer to aforementioned embodiments without more depiction here.

Step 402: exhibiting the commodity marking result.

In this embodiment of the disclosure, the third terminal displays the commodity marking result after receiving the commodity marking results of the first shelf and the second shelf sent by the server. The store clerk may review the commodity marking result on the third terminal directly and adjust the commodities displayed on the shelf quickly according to the commodity marking result. It is saving the time spent by store clerk, improving the efficiency for sorting commodity, and reducing the difficulty of commodity sorting.

Specifically, step 402 includes sub-step S21:

Sub-Step S21: displaying the marking result of each position in specified shelf on a shelf interface.

In practical applications, when the commodity marking result is received, the marking result at each position in the specified shelf on the shelf interface is displayed firstly. The marking result includes the commodity addition mark, the commodity off-shelf mark, the commodity replacing mark, and the commodity unchanged mark, the specified shelf is any one shelf of the second shelf, the fourth shelf or the fifth shelf.

Specifically, when the specified shelf is the second shelf, the second shelf identifier corresponding to the second shelf is the same as the target shelf identifier, the target shelf identifier is any one of the first shelf identifiers in the target template data, and the fourth shelf refers to the new added shelf, the fifth shelf refers to the unnecessary shelf that needs to be removed.

It is necessary to replace the commodity at the corresponding position of the commodity addition mark, commodity off-shelf mark, and commodity replacing mark, and it is not necessary to replace the commodity at the position corresponding to the commodity unchanged mark. Therefore, the other marks other than the commodity unchanged mark in the marking result and the commodity unchanged mark are displayed with different display effects on the shelf interface, to enable the store clerk to locate the position of the commodity that needs to be replaced quickly. Wherein, the display effect includes one or more of a display color, a display pattern, and a background hatch pattern, that is, the other marks other than the commodity unchanged mark in the marking result and the commodity unchanged mark are displayed in different display color, display pattern, background hatch pattern, etc.

Certainly, in order to further clarify the actual change method at the location of the commodity that needs to be changed, that is, whether it needs to add a new commodity, remove the commodity, or replace the commodity at the location of the commodity needs to be changed, additionally, the display effect at the position corresponding to the commodity addition mark, the commodity off-shelf mark and the commodity replacing mark is also different.

For example, the display color at the position corresponding to the commodity unchanged mark is white, which means the position corresponding to the commodity unchanged mark is displayed in white; the display color at the position corresponding to the commodity addition mark is red, which means the position corresponding to the commodity addition mark is displayed in red; the display color at the position corresponding to the commodity off-shelf mark is green, which means the position corresponding to the commodity off-shelf mark is displayed in green; the display color at the position corresponding to the commodity replacing mark is yellow, which means the position corresponding to the commodity replacing mark is displayed in yellow.

As referring in FIG. 5, the shelf interface 60 includes a first area 61, a second area 62, a third area 63, a fourth area 64, and a fifth area 65. The first area 61 is used to display the search box. The store clerk may enter the shelf identifier or commodity identifier in the search box to query the specified status of the shelf or commodity; the second area 62 is used to display the number of the first shelf included in the template data and the number of the second shelf included in the collecting data, that is, the template data includes 100 shelf, and the collecting data also includes 100 shelf; The third area 63 is used to display the shelf identifier corresponding to the specified shelf, for example, the shelf identifier of the specified shelf is 12000A5B. The third area 63 is further used to display the specified date of the target time point (that is, the time, that the second terminal sends a comparison instruction to the server to compare the target template data with target collecting data), such as 06/12/2019, the third area 63 is further used to display the number of positions of commodity that need to be changed on the specified shelf, for example, the number of positions of commodity that need to be changed in the shelf corresponding to the shelf ID 12000A5B is 4, that is, the remaining difference is 4; The third area 63 is used to display the shelf identifier corresponding to the specified shelf, for example, the shelf identifier of the specified shelf is 12000A5B. The third area 63 is further used to display the specified date of the target time point (that is, the time, that the second terminal sends a comparison instruction to the server to compare the target template data with target collecting data), such as 06/12/2019, the third area 63 is also used to display the number of positions of the commodity that need to be changed on the specified shelf, such as the number of positions of the commodity that need to be changed on the specified shelf corresponding to the shelf ID 12000A5B is 4, that is, the remaining difference is 4. The fourth area 64 is used to display the marking results of each of the positions in the specified shelf, for example, the specified shelf includes five floors, namely the first floor, the second floor, the third floor, the fourth floor and the fifth floor. The sixth position 641 of the first floor is displayed in the first color, the seventh position 642 of the second floor is displayed in the second color, the fourth position 643 of the third floor is displayed in the third color, and the seventh position 644 of the fourth floor is displayed in the third color, and the other positions 645 are displayed in the fourth color. The first color is used to display the commodity addition mark, the second color is used to display the commodity off-shelf mark, the third color is used to display the commodity replacing mark, and the fourth color is used to display the commodity unchanged mark, that is, new commodities are needed to be added at position 641 in the first floor, the commodities are needed to be removed at the seventh position 642 on the second floor from the shelf, the commodities are needed to be replaced at the fourth position 643 on the third floor, the commodities are also needed to be replaced at the seventh position 644 on the fourth floor. Wherein, the fourth color is different from the first color, the second color, and the third color, and the first color, the second color, and the third color may be the same or different.

In addition, the shelf interface also displays the marking information of other shelves other than the specified shelf. The marking information includes the number of positions of the commodity that need to be changed on the specified shelf.

As referring in FIG. 5, the fifth area 65 of the shelf interface 60 displays the marking information of other shelf other than the specified shelf, for example, the shelf identifier of the specified shelf is 12000A5B, and the shelf identifiers of other shelves other than the specified shelf are 12000A6B and 12000A7B. The marking information displayed in the fifth area 65 includes the number of positions of the commodity that need to be changed in the shelf corresponding to the shelf identifier 12000A6B is 2, that is, the remaining difference is 2. The marking information displayed in the fifth area 65 also includes the number of positions of the commodity that need to be changed in the shelf corresponding to the shelf identifier 12000A7B, the marking information further includes the shelf identifiers corresponding to other shelf other than the specified shelf, such as shelf identifiers 12000A6B and 12000A7B. The marking information further includes the specified date of the target time point (that is, the time, that the second terminal sends a comparison command to the server to compare the target template data with the target), such as 06/12/2019.

As referring in FIG. 5, according to the shelf interface 60, the store clerk may see number of the floors of the current specified shelf, which commodities are needed to be adjusted on positions of each floor on the specified shelf, and the store clerk may also know the remaining difference between the specified shelf and other shelf except the specified shelf, in the target template data.

After sub-step S21, the step 402 further includes sub-step S22 and sub-step S23:

sub-step S22: receiving a user's selecting operation for a specified area of the specified shelf in the shelf interface.

sub-step S23: displaying a commodity marking interface corresponding to a position of the specified area according to the selecting operation.

After checking the shelf interface 60, the store clerk may perform touch operations on the specified area of the specified shelf in the shelf interface, when the store clerk needs to review the specified commodity information that needs to be changed, such as clicking, double-clicking, etc., and the third terminal receives the store clerk's selecting operation for a specified area of the specified shelf, and according to the selection operation, the commodity marking interface at the position corresponding to the specified area is displayed. Wherein, the commodity marking interface includes the mark pattern corresponding to the commodity category and the marking result, and the commodity category includes the commodity name and/or the commodity identifier.

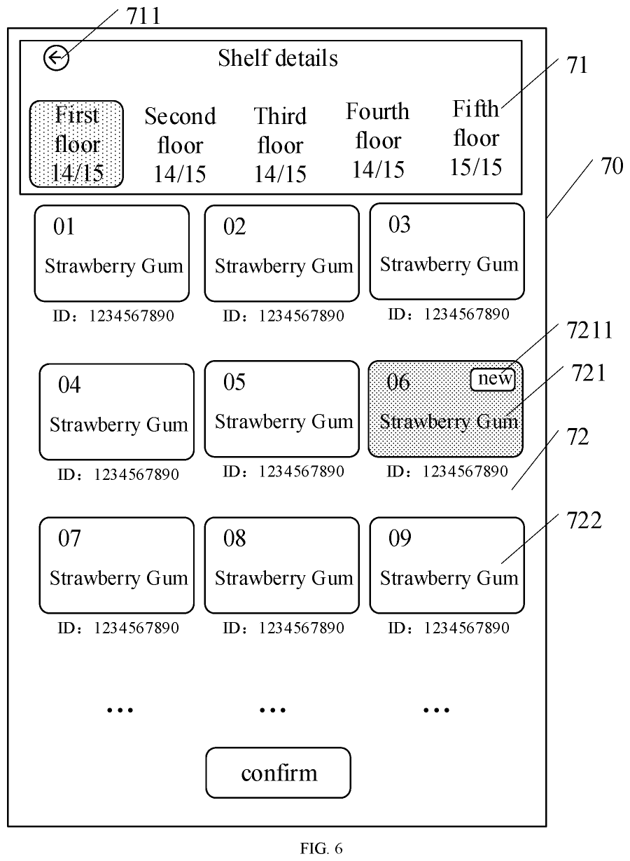

When the store clerk clicks the specified area is the area on the first floor of the specified shelf on the fourth area on the shelf interface 60 shown in the FIG. 5, the shelf interface 60 shown in the FIG. 5 is jumped to the commodity marking interface 70 shown in the FIG. 6 in the third terminal. The commodity marking interface 70 includes a sixth area 71 and a seventh area 72. The sixth area 71 is used to display each of the floors, the number of the positions includes in each floor, and the number of positions of the commodity that not need to be changed on the specified shelf corresponding to the shelf interface 60. For example, the number of positions included in the first floor is 15, the number of positions of the commodity that not need to be changed is 15, that is 14/15, the number of positions included in the first floor, in the second floor and in the third floor is 15, and the number of positions of the commodity that not need to be changed is 15, that is 14/15, the number of positions included in the fifth floor is 15, and the number of positions of the commodity that not need to be changed is 15, that is 15/15, it is not necessary to replace the commodity on the fifth floor. In the practical process of the display, it may be used a specified pattern to identify the floor of the specified area, as referring in the FIG. 6, the specified area is on the first floor; certainly, a return control 711 is also provided in the sixth area 71, when the store clerk clicks the return control 711, the commodity marking interface 70 returns to the shelf interface 60 shown in FIG. 5.

The seventh area 72 is used to display the commodity status at each of the positions on the first floor, the commodity status includes the mark pattern corresponding to the commodity category and the marking result. As referring in FIG. 6, the commodity name in the commodity category included at the sixth position 721 on the first floor is “Strawberry Gum” with the commodity identifier “1234567890”, and the marking result at the sixth position 721 on the first floor is the commodity addition mark, and the mark pattern corresponding to the commodity addition mark is shown in 7211, and the commodity category displayed at the sixth position 721 of the first floor is a commodity category that needs to be added; and the commodity name included the commodity category shown in FIG. 6 at other locations 722 is “Strawberry Gum” with the commodity identifier is “1234567890”. Since all of the marking results at the other locations at 722 shown in FIG. 6 are commodity unchanged marks, the mark pattern corresponding to the commodity unchanged mark at other positions 722 other than 721 shown in FIG. 6 may not be displayed.

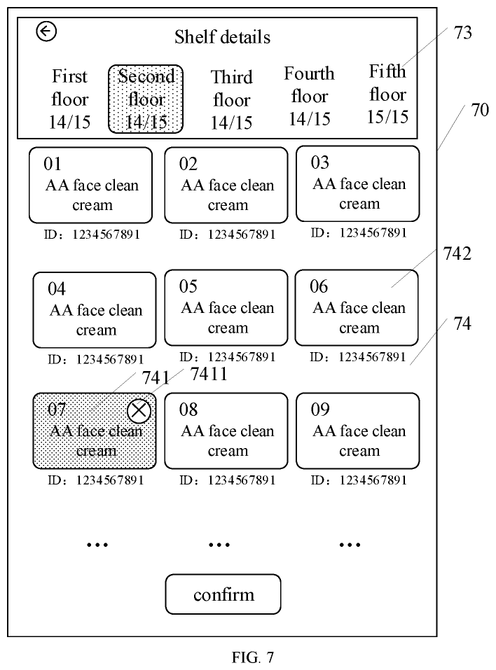

When the store clerk clicks the area of the second floor on the specified shelf in the fourth area 64 of the shelf interface 60 shown in FIG. 5 the specified area, the interface of the third terminal jumps from the shelf interface 60 shown in FIG. 5 to the commodity marking interface 70 shown in FIG. 7, the commodity marking interface 70 includes an eighth area 73 and a ninth area 74. The eighth area 73 shown in FIG. 7 is basically the same as the sixth area 71 shown in FIG. 6, except that the eighth area 73 shown in FIG. 7 uses a specified pattern to mark the second layer in the specified area; the ninth area 74 is used to display the commodity status at each of the positions of the second floors, the commodity status includes the mark pattern corresponding to the commodity category and the marking result, as referring in FIG. 7, the commodity name in commodity category at the seventh position 741 of the second floor is “AA face clean cream” with commodity identifier “1234567891”, and the marking result at position 741 at the seventh position of the second floor is commodity off-shelf mark, The pattern corresponds to the commodity off-shelf mark is shown as 7411. And, the commodity category displayed at the seventh position 741 on the second floor is the commodity category that needs to be removed from the current shelf; while the commodity name included in the commodity category at the other position 742 shown in FIG. 7 is “AA face clean cream” with the commodity identifier “1234567891”. Since all of the marking results of the other positions 742 shown in FIG. 7 are the commodity unchanged marks, the mark pattern corresponding to the commodity unchanged mark at other position 742 other than 741 in FIG. 7 may not be displayed.

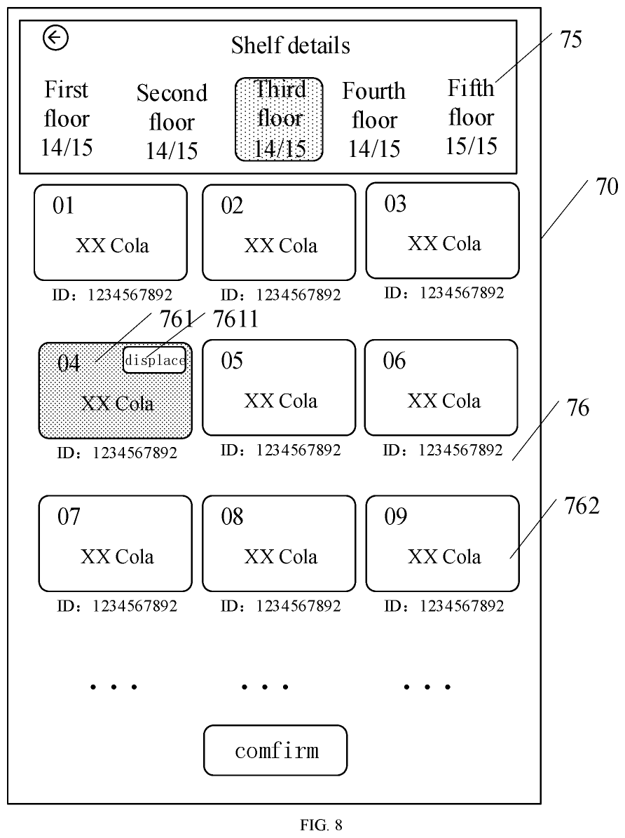

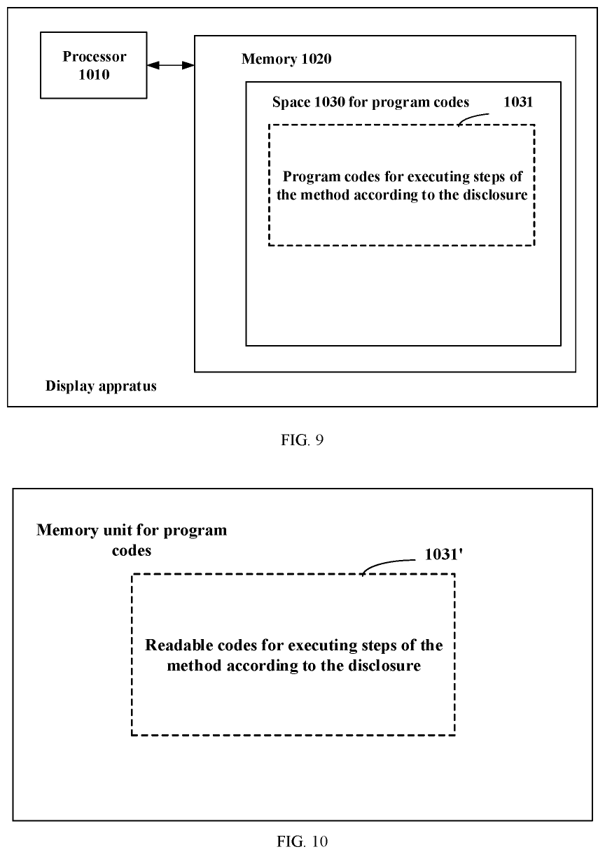

When the specified area clicked by the store clerk is the area on the third floor of the specified shelf in the fourth area 64 in the shelf interface 60 shown in FIG. 5, the interface of the third terminal jumps from the shelf interface 60 shown in FIG. 5 to the commodity marking interface 70 shown in FIG. 8. The commodity marking interface 70 includes a tenth area 75 and an eleventh area 76. The tenth area 75 shown in FIG. 8 is basically the same as the sixth area 71 shown in FIG. 6, except that the tenth area 75 shown in FIG. 8 uses a specified pattern to indicate the third floor; The eleventh area 76 is used to display the commodity status at each of the positions on the third floor, the commodity status includes the mark pattern corresponding to the commodity category and the marking result. As shown in FIG. 8, the commodity name in the commodity category included at the fourth position 761 of the third floor is “XX Cola” with the commodity identifier is “1234567892”. the marking result at the fourth position 761 of the third floor is the commodity replacing mark, then the mark pattern corresponding to the commodity replacing mark is shown as 7611, and the commodity category displayed at the fourth position 761 of the third floor is the commodity category that needs to be replayed at that location after the replacement; the commodity name in the commodity category included at the other position 762 shown in FIG. 8 is “XX Cola” with the commodity identifier is “1234567892”. As all of the marking results at the other positions 762 shown in FIG. 8 are the commodity unchanged marks, the mark pattern corresponding to the commodity unchanged mark at position 762 other than 761 in FIG. 8 may not be displayed.

By displaying of the commodity addition mark, commodity off-shelf mark, and commodity replacing mark with the different mark patterns in the commodity marking interface 70, the store clerk may understand whether the commodity that needs to be adjusted, needs to be added, needs to be off-shelf or needs to be replaced, it is reducing the time for the judgment and comparison by store clerk.

It should be noted that, when the third terminal and the second terminal are the same terminal, it further includes before step 401: collecting and sending the at least one piece of collecting data to the server.

In this embodiment of the disclosure, the commodity marking results of the shelf in the target template data and the target collecting data are obtained by sending both of the target template data and the target collecting data to the server and comparing the target template data and the target collecting data in the server, After that, the commodity marking results of the shelf are sent to the third terminal from the server, and the store clerk may review the commodity marking results on the third terminal directly and adjust the commodities displayed on the shelf according to the commodity marking results quickly. It is not only saving the time spent on commodities sorting of the store clerk and improving the efficiency of commodities sorting, but also reducing the difficulty of commodities sorting.

The disclosure further provides a commodity exhibiting method, the system includes the server and the terminal in the embodiments described above, the terminal refers to the third terminal.

Further, the commodity exhibiting method further includes a first terminal and a second terminal; the first terminal is configured to send the at least one piece of template data to the server; the second terminal is configured to collect and send the at least one piece of collecting data to the server.

The server is configured to receive the at least one piece of template data sent by the first terminal and the at least one piece of collecting data sent by the second terminal; to determine target template data from the at least one piece of template data, and to determine target collecting data from the at least one piece of collecting data; The template data is compared with the target collecting data, and the location difference is marked to obtain the first shelf and second shelf commodity marking results; the commodity marking result is sent to the third terminal.

The third terminal is configured to receive the commodity marking result sent by the server; to display the commodity marking result.

The description for the process of the specified execution of the server and the third terminal may be refer to aforementioned embodiments without more depiction here.

In this embodiment of the disclosure, the commodity marking results of the shelf in the target template data and target collecting data are obtained by sending both of the target template data and the target collecting data to the server and comparing the target template data and the target collecting data in the server, After that, the commodity marking results of the shelf are sent to the third terminal from the server, the third terminal receives the commodity marking results of the first shelf and the second shelf sent by the server, and displays the commodity marking results. The store clerk may review the commodity marking result on the third terminal directly and adjust the commodities displayed on the shelf according to the commodity marking result quickly. It is not only saving the time spent on commodities sorting of the store clerk and improving the efficiency of commodities sorting, but also reducing the difficulty of commodities sorting.

Correspondingly, this embodiment of the disclosure further discloses a server, comprises a processor, a memory and a computer program stored in the memory and capable to be executed by the processor, and the computer program is executed by the processor to implement the steps of the commodity marking method as mentioned above.

This embodiment of the disclosure further discloses a terminal, comprises a processor, a memory and a computer program stored in the memory and capable to be executed by the processor, and the computer program is executed by the processor to implement the steps of the commodity exhibiting method as mentioned above.

This embodiment of the disclosure further discloses a computer readable storage medium, wherein the computer program is stored on the computer readable storage medium and the computer program is executed by the processor to implement the steps of the commodity marking method and the commodity exhibiting method as mentioned above.

For the implementation examples of the above methods, in order to describe them simply, they are expressed as a series of action combinations. However, technical personnel in this field should know that this disclosure is not limited by the described action sequence, because according to this disclosure, some steps may be carried out in other sequences or at the same time. Secondly, the technical personnel in this field should also know that the implementation described in the instructions are all preferred implementation cases, and the actions and modules involved are not necessarily necessary for the disclosure.

The apparatus implementation cases described above are only schematic, in which the units described as the separation components may be or may not be physically separated, and the shown as units may be or may not be physical units, that is, they may be located in one place or may be distributed to multiple network units. Some or all of the modules may be selected according to the actual needs to achieve the purpose of this implementation scheme. Ordinary technicians in this field may understand and implement without paying creative labor.

The implementation examples of each component in this paper may be implementd by hardware, or by software modules running on one or more processors, or by their combination. Technicians in this field should understand that microprocessors or digital signal processors (DSPs) may be used in practice to achieve some or all of the functions of some or all parts of the display device according to this public embodiment. This disclosure may also be implemented as part or all of the equipment or apparatus used to implement the method described here (for example, computer programs and computer program products). This open program may be stored in a computer readable medium, or may have one or more signals. Such signals may be downloaded from the Internet site, or provided on the carrier signal, or provided in any other form.

For example, FIG. 9 shows a display device that may implement the method exposed according to this. The display device traditionally includes a processor 1010 and a computer program product or computer readable medium in the form of memory 1020. Memory 1020 may be an electronic memory such as flash memory, EEPROM (electrically erasable programmable Read-only memory), EPROM, hard disk, or ROM. Memory 1020 has storage 1030 for program code 1031 for performing any of the method steps described above. For example, storage 1030 for program code could include individual program code 1031 for implementing the various steps in the method above. The program code may be read from or written to one or more computer program products. These computer program products include program code carriers such as hard disks, compact disks (CDS), memory cards, or floppy disks. Such computer program products are usually portable or stationary storage units as described in FIG. 8. The storage unit may have segments, storage space, and so on arranged in a manner similar to memory 1020 in the display device in FIG. 9. The program code may, for example, be compressed in an appropriate form. Typically, the storage unit includes computer-readable code 1031′, that is, code that may be read by a processor such as 1010, which, when run by a display unit, causes the display unit to perform the steps in the method described above.

The description provided herein describes many concrete details. However, it can be understood that the embodiments of the present disclosure may be implemented without those concrete details. In some of the embodiments, well-known processes, structures and techniques are not described in detail, so as not to affect the understanding of the description.

All embodiments in this manual are described in a progressive manner. Each embodiment focuses on the differences with other embodiments, and the same and similar parts among all embodiments may be referred to each other.

Finally, it should be noted that, in this article, relational terms such as first and second classes are used only to distinguish one entity or operation from another, and do not necessarily require or imply any such actual relationship or order between these entities or operations. Also, the term “including” and “include” or any of its other variants is intended to cover a non-exclusive contain, which includes a series of elements of the process, method, product or equipment include not only those elements, but also no clear list of other elements, or is also included for the process, method, product or equipment inherent elements. Without further restriction, the statement “includes a . . . A qualified element does not exclude the existence of other identical elements in the process, method, goods or equipment that includes the element.

A commodity marking method, a commodity exhibiting method, a server, a terminal, and a commodity exhibiting method provided in this disclosure are introduced in detail above. In this paper, specific cases are applied to illustrate the principle and implementation of this disclosure. The above embodiments are only used to help understand the disclosed method and its core ideas; at the same time, for the general technical personnel in this field, there will be changes in the specific implementation mode and application scope according to the ideas of this disclosure. In summary, the contents of this manual shall not be understood as restrictions on this disclosure.

1. A commodity marking method, wherein the method is applied to a server, and the method comprises:
receiving at least one piece of template data sent by a first terminal and at least one piece of collecting data sent by a second terminal;
determining target template data from the at least one piece of template data, and determining target collecting data from the at least one piece of collecting data; the target template data comprise first shelf identifiers corresponding to at least one first shelf, each of the at least one first shelf comprises a plurality of first locations that are capable of storing commodity, the target collecting data comprise second shelf identifiers corresponding to at least one second shelf, each of the at least one second shelf comprises a plurality of second locations that are capable of storing commodity;
comparing the target template data with the target collecting data and marking a difference in location, to obtain a commodity marking result of the at least one first shelf and the at least one second shelf; and
sending the commodity marking result to a third terminal.

2. The method according to claim 1, wherein the target template data further comprises a location identifier corresponding to each of the first locations and first commodity status at each of the first locations; and
the target collecting data further comprise a location identifier corresponding to each of the second locations, and second commodity status at each of the second locations.

3. The method according to claim 2, wherein the step of comparing the target template data with the target collecting data and marking a difference in location, to obtain the commodity marking result of the at least one first shelf and the at least one second shelf, comprises:
determining whether a second shelf identifier which is consistent with a target shelf identifier exists in the target collecting data; wherein the target shelf identifier is any one of the first shelf identifiers;
on the condition that the second shelf identifier which is consistent with the target shelf identifier exists in the target collecting data, determining whether the first target commodity status is consistent with the second target commodity status;
wherein, the first target commodity status refers to the first commodity status at a first target location in the first shelf corresponding to the target shelf identifier, the second target commodity status refers to the second commodity status at a second target location in the second shelf corresponding to the target shelf identifier, the first target location and the second target location have a same location identifier, the first target location is any one of the first locations, and the second target location is any one of the second locations; and
adding a first marking result to the second target commodity status, on the condition that the first target commodity status is inconsistent with the second target commodity status.

4. The method according to claim 3, wherein after the step of determining whether the first target commodity status is consistent with the second target commodity status, the method further comprises:
adding a second marking result to the second target commodity status, on the condition that the first target commodity status is consistent with the second target commodity status; the second marking result is a commodity unchanged mark.

5. The method according to claim 3, wherein the first commodity status comprises the status of commodities displayed at the first location, and the status of no commodities displayed at the first location; the second commodity status comprises the status of commodities displayed at the second location, and the status of no commodities displayed at the second location; and
the first marking result comprises a commodity addition mark, a commodity off-shelf mark and a commodity replacing mark.

6. The method according to claim 5, wherein the step of adding a first marking result to the second target commodity status, on the condition that the first target commodity status is inconsistent with the second target commodity status, comprises:
adding the commodity addition mark to the second target commodity status, on the condition that commodities displayed at the first target location and no commodities displayed at the second target location, and adding a commodity category needed to be added to the second target commodity status according to the commodities displayed at the first target location;
adding the commodity off-shelf mark to the second target commodity status, on the condition that no commodities displayed at the first target location and commodities displayed at the second target location; and
adding the commodity replacing mark to the second target commodity status, on the condition that commodities displayed at both of the first target location and the second target location, and the commodity categories of the commodities displayed at the first target location and the second target location are different, and adding a replaced commodity category to the second target commodity status according to the commodities displayed at the first target location.

7. The method according to claim 3, wherein after the step of determining whether a second shelf identifier which is consistent with a target shelf identifier exists in the target collecting data the method further comprises:
on the condition that a third shelf identifier which is not comprised by the target collecting data exists in the target template data, adding a third marking result to the target collecting data according to the third commodity status of each third location of each third shelf corresponding to each of third shelf; and
wherein the third marking result comprises a shelf addition mark corresponding to a fourth shelf identifier, the commodity addition marks and the commodity categories needed to be added to a fourth commodity status at each fourth location of each of fourth shelf corresponding to the fourth shelf identifier, wherein the fourth shelf identifier is consistent with the third shelf identifier.

8. The method according to claim 3, wherein after the step of determining whether the second shelf identifier which is consistent with the target shelf identifier exists in the target collecting data the method further comprises:
adding a fourth marking result to the target collecting data on the condition that a fifth shelf identifier which is not comprised by the target template data exists in the target collecting data; and
the fourth marking result comprises a shelf deletion mark corresponding to the fifth shelf identifier, and a commodity off-shelf mark added to the fifth commodity status at each fifth location of each of the fifth shelf corresponding to the fifth shelf identifier.

9. The method according to claim 1, wherein, each piece of the template data comprises a first timestamp, each piece of the collecting data comprises a second timestamp;
the step of determining the target template data from the at least one piece of template data, and determining the target collecting data from the at least one piece of collecting data, comprises:
determining the collecting data which is corresponding to the second timestamp closest to a target time point as the target collecting data; and
determining the template data which is corresponding to the first timestamp matched to the second timestamp comprised in the target collecting data as the target template data.

10. A commodity exhibiting method, wherein the method is applied to a terminal, and the method comprises:
receiving a commodity marking result sent from a server;
wherein the commodity marking result refers to the result obtained by comparing and marking of target template data and target collecting data, wherein, the target template data comprise at least one first shelf identifier corresponding to a first shelf, each of the at least one first shelf comprises a plurality of first locations that are capable of storing commodity, and the target collecting data comprise at least one second shelf identifier corresponding to a second shelf, each of the at least one second shelf comprises a plurality of second locations that are capable of storing commodity; and
exhibiting the commodity marking result.

11. The method according to claim 10, wherein the step of exhibiting the commodity marking result, comprises:
displaying the marking result of each position in a specified shelf on a shelf interface;
wherein, the marking result comprises a commodity addition mark, a commodity off-shelf mark, a commodity replacing mark and a commodity unchanged mark, the specified shelf is any one shelf of a second shelf, a fourth shelf or a fifth shelf.

12. The method according to claim 11, wherein, the shelf interface further displays marking information of other shelves other than the specified shelf, the marking information comprises a quantity of positions that the commodity needed to be replaced in other shelves other than the specified shelf.

13. The method according to claim 11, wherein other marks other than the commodity unchanged mark in the marking result, and the commodity unchanged mark, are displayed at the corresponding position in the shelf interface with different display effects; and
wherein, the display effect comprises one or more of a display color, a display pattern and a background hatch pattern.

14. The method according to claim 11, wherein after displaying the marking result of each position in specified shelf on the shelf interface, the method further comprises:
receiving a user's selecting operation to a specified area of the specified shelf in the shelf interface;
displaying a commodity marking interface corresponding to a position of the specified area according to the selecting operation; and
wherein, the commodity marking interface comprises the commodity category and a mark pattern corresponding to the marking result, the commodity category comprises a commodity name and/or a commodity identifier.

15. A server, wherein the server comprises a processor, a memory, and a computer program stored on the memory and the computer program is executed by the processor to implement the steps of the commodity marking method according to claim 1.

16. A terminal, wherein the terminal comprises a processor, a memory, and a computer program stored on the memory and the computer program is executed by the processor to implement the steps of the commodity exhibiting method according to claim 10.

17. (canceled)

18. A commodity exhibiting system, wherein the system comprises a server and a terminal, wherein the server comprises a first processor, a first memory, and a first computer program stored on the first memory and the first computer program is executed by the first processor to implement the steps of the commodity marking method, comprising:
receiving at least one piece of template data sent by a first terminal and at least one piece of collecting data sent by a second terminal;
determining target template data from the at least one piece of template data, and determining target collecting data from the at least one piece of collecting data; the target template data comprise first shelf identifiers corresponding to at least one first shelf, each of the at least one first shelf comprises a plurality of first locations that are capable of storing commodity, the target collecting data comprise second shelf identifiers corresponding to at least one second shelf, each of the at least one second shelf comprises a plurality of second locations that are capable of storing commodity;
comparing the target template data with the target collecting data and marking a difference in location, to obtain a commodity marking result of the at least one first shelf and the at least one second shelf; and
sending the commodity marking result to a third terminal;
wherein the terminal comprises a second processor, a second memory, and a second computer program stored on the second memory and the second computer program is executed by the second processor to implement the steps of the commodity exhibiting method, comprising:
receiving a commodity marking result sent from a server;
wherein the commodity marking result refers to the result obtained by comparing and marking of target template data and target collecting data, wherein, the target template data comprise at least one first shelf identifier corresponding to a first shelf, each of the at least one first shelf comprises a plurality of first locations that are capable of storing commodity, and the target collecting data comprise at least one second shelf identifier corresponding to a second shelf, each of the at least one second shelf comprises a plurality of second locations that are capable of storing commodity; and
exhibiting the commodity marking result,
wherein the terminal refers to the third terminal.

19. The system according to claim 18, wherein the system further comprises the first terminal and the second terminal;
the first terminal is configured to send at least one piece of the template data to the server; and
the second terminal is configured to collect and send at least one piece of the collecting data to the server.

20. The system according to claim 18, wherein the server is configured to:
receiving at least one piece of the template data sent by the first terminal, and at least one piece of the collecting data sent by the second terminal;
determining target template data from at least one piece of template data, and determining the target collecting data from at least one piece of the collecting data; the target template data comprises at least one first shelf identifier corresponding to a first shelf, each of the at least one first shelf comprises a plurality of first locations that are capable of storing commodity, the target collecting data comprise at least one second shelf identifier corresponding to a second shelf, each of the at least one second shelf comprises a plurality of second locations that are capable of storing commodity; and
comparing the target template data with the target collecting data and marking the differences in locations, to obtain the commodity marking result of the at least one first shelf and the at least one second shelf; and
sending the commodity marking result to the third terminal.

21. The system according to claim 18, wherein, the third terminal is configured to:
receiving the commodity marking result sent by the server;
wherein the commodity marking result refers to the result obtained by comparing and marking of the target template data and target collecting data, wherein, the target template data comprises first shelf identifiers corresponding to at least one first shelf, each of the at least one first shelf comprises a plurality of first locations that are capable of storing commodity, and the target collecting data comprise second shelf identifiers corresponding to at least one second shelf, each of the at least one second shelves comprises a plurality of second locations that are capable of storing commodity; and
exhibiting the commodity marking result.

22. (canceled)
